(19) United States
(12) Patent Application Publication
(10) Pub. No.: US 2008/0161089 A1
(43) Pub. Date: Jul. 3, 2008

(54) Surface Conduction Electron Emitter Display in a Wagering Game System

(75) Inventors: John M. Dahl, Plymouth, MN (US); Richard T. Schwartz, Chicago, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS GAMING INC., Waukegan, IL (US)

(21) Appl. No.: 11/575,442

(22) PCT Filed: Sep. 8, 2005
(86) PCT No.: PCT/US05/31993

§ 371 Date: Sep. 10, 2007

Related U.S. Application Data
(60) Provisional application No. 60/610,268, filed on Sep. 16, 2004.

(51) Int. Cl. G06F 17/00

(52) U.S. Cl. 463/20

(57) ABSTRACT

A computerized wagering game system has a surface conduction electron emitter display. In various further embodiments, the display is a main system display, a top box display, or a side panel display.

### RELATED APPLICATION

This application claims the priority benefit of U.S. Provisional Application Ser. No. 60/610,268, filed 16 Sep. 2004, the contents of which are incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD OF THE INVENTION

The invention relates generally to wagering gaming systems, and more specifically to a wagering game machine employing a surface conduction electron emitter display.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computerized wagering game systems have a variety of sound and graphical elements designed to attract and keep a game player's attention, such as sound effects, music, and animation. The visual elements presented in wagering games has progressed from simple rotation of slot machine reels and other mechanical movements to computerized systems that include a variety of animation, video, and other such effects. This requires incorporation of a display into the wagering game machine, such as a cathode-ray tube (CRT), a liquid crystal display (LCD), or a plasma display screen.

Each of these technologies have advantages and disadvantages. CRTs provide good brightness and color fidelity, but are physically large and consume a relatively large amount of power. LCDs have limited brightness, and backlighting the display panel evenly and achieving accurate color fidelity are difficult. Plasma displays consume relatively large amounts of power, and are expensive to produce. All three are difficult to produce in large sizes, and production yields drop quickly as screen size becomes large.

It is desired to employ display technology that provides accurate color, low power consumption, high resolution, and low cost.

### SUMMARY OF THE INVENTION

The present invention provides in one embodiment a computerized wagering game system having a surface conduction electron emitter display. In various further embodiments, the display is a main system display, a top box display, or a side panel display.

### BRIEF DESCRIPTION OF THE FIGURES

FIG. 1 shows a computerized wagering game machine having a surface conduction electron emitter display, consistent with an example embodiment of the present invention.

FIG. 2 is a side view of a surface conduction electron emitter display, consistent with an embodiment of the present invention.

FIG. 3 is a front view of a computerized wagering game system comprising a surface conduction electron emitter display, consistent with an example embodiment of the present invention.

FIG. 4 is an alternate view of a computerized wagering game system comprising a surface conduction electron emitter display, consistent with an example embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized wagering game system having a surface conduction electron emitter display. The display in various embodiments is employed as a main system display, and in other embodiments is contained in a top box or in an alternate location on the wagering game machine. Various examples also include using the surface conduction electron emitter display to display wagering game elements, attract mode animations, and other video material.

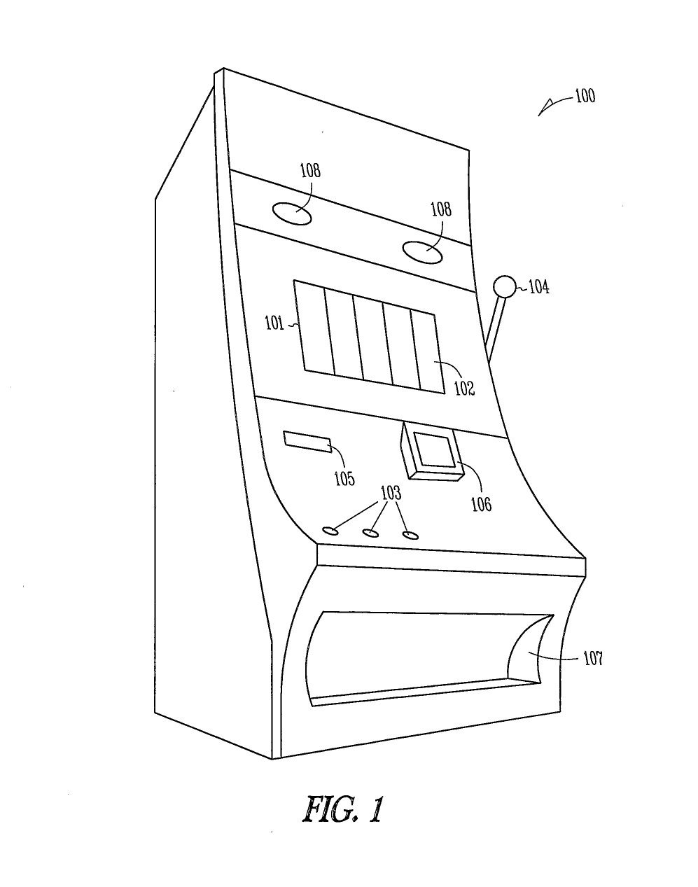

FIG. 1 illustrates a computerized wagering game machine, consistent with an embodiment of the present invention. The computerized gaming system shown generally at 100 is a video gaming system, which displays information for at least one wagering game upon which monetary value can be wagered on surface conduction electron emitter display 101. Alternate embodiments of the invention will have other game indicators, such as mechanical reels instead of the video graphics reels 102, and will employ a surface conduction electron emitter display elsewhere in the computerized wagering game system.

The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a secure user identification module interface 106, and winnings are returned via the returned value card or through the coin tray 107. Sound is also provided through speakers 108.

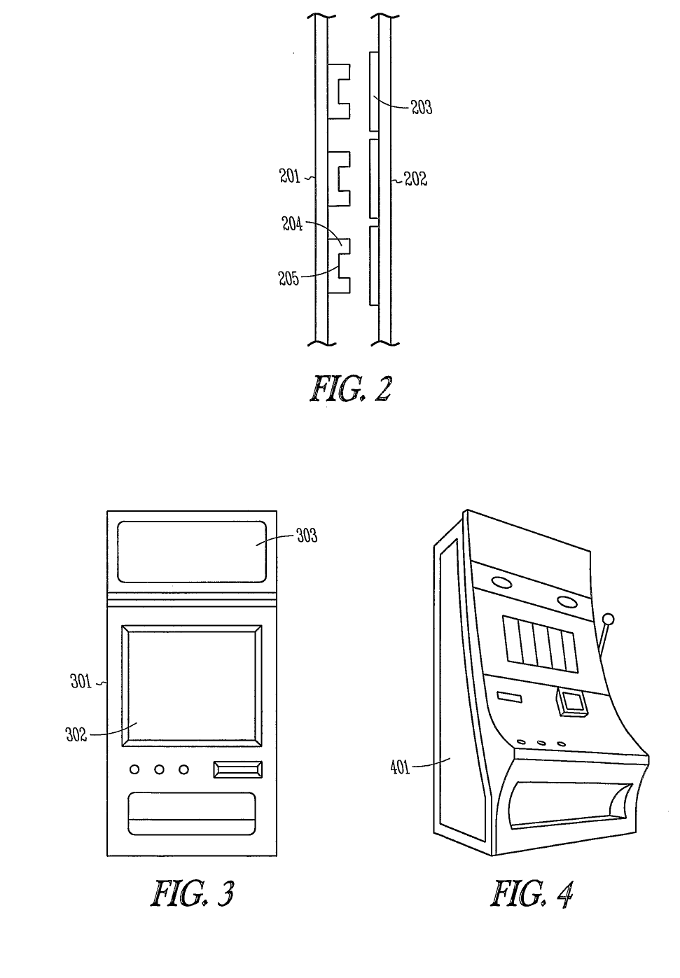

The surface conduction electron emitter display 101 is desirable relative to other display technologies due to the relatively low cost, color accuracy, brightness, and power efficiency provided by surface conduction electron emitter displays. FIG. 2 shows a side view of a surface conduction electron emitter display, consistent with an embodiment of the present invention. A first glass plate 201 is mounted near a second glass plate 202, with a vacuum in between the glass plates. The inside of the glass plate 203 is coated with phosphor, which in various embodiments are selected to produce different colors of light when struck with electrons. A plurality of electrodes 204 are configured such that a narrow slit 205 separates them.

In operation, a voltage is applied to the electrodes 204 such that there is a voltage differential across slit 205, which causes the electrodes 204 to emit electrons. This occurs in one example embodiment due to a tunneling effect between the electrodes at different voltage potentials. The emitted electrons travel through the vacuum and strike the phosphor 203, causing light to be emitted through the glass panel 202. Large arrays of such surface conduction electron emitters are produced to create large displays, such as display 101 of the computerized wagering game system of FIG. 1.

The surface conduction electron emitter display of FIG. 2 has individually addressable pixels, and in various embodiments is monochrome or color. In one example embodiment, color phosphors as are presently used in cathode ray tube displays to produce red, blue, and green dots of light are employed to produce a color surface conduction electron emitter display. Because phosphors for cathode ray tubes have been researched and refined for many years for application to color displays, they are particularly well-suited for surface conduction electron emitter display applications where color accuracy is important.

The estimated efficiency of a surface conduction electron emitter display is approximately five lumens per Watt or higher, resulting in an energy efficiency rate that is approximately twice that of cathode ray tube displays and about a third that of plasma displays. The size and cost of surface conduction electron emitter displays is also believed to be a significant improvement over other display options for wagering game application, due in part to the way in which surface conduction electron emitter displays can be fabricated. Some manufacturers are simply using inkjet or bubblejet printing technology to print electrodes 204 having a narrow slit 205 on a substrate such as glass panel 201, and are similarly printing the interconnect wiring linking the electrodes to drive circuitry on the substrate. The remaining glass element 202 can be coated with phosphors using technology and machinery already existing for cathode ray tube production, making configuration of a surface conduction electron emitter display production facility and production of the displays themselves inexpensive relative to other competing display technologies.

FIGS. 3 and 4 illustrate a few examples of ways in which a surface conduction electron emitter display may be incorporated into a wagering game machine, consistent with some embodiments of the present invention. A wagering game machine such as that of FIG. 1 is shown in FIG. 3, but incorporating a top box. The wagering game main display 302 or the to box display 303 are in various examples surface conduction electron emitter displays, and in further embodiments are both present and are both surface conduction electron emitter displays. In another example, a side panel display shown at 401 of FIG. 4 is a surface conduction electron emitter display. Use of surface conduction electron emitter display technology is particularly well-suited to this application because of the relatively low cost, the ability to produce relatively large display panels, and because of the inherent thinness of surface conduction electron emitter displays. Side panel display 401 in particular would be extremely difficult to produce using LCD or plasma technology because of the size and unusual shape, and would be practically impossible to produce using traditional cathode ray tube technology.

The low power consumption of surface conduction electron emitter displays in devices employing multiple displays is of further benefit to reduce power consumption in environments where power is expensive, where many machines are powered on at he same time, or where power availability is limited such as on a riverboat. The reduction in consumed power further benefits a wagering game machine operator in reducing the heat produced, lessening the environmental cooling or air conditioning demands in establishments employing several such wagering game machines.

The examples discussed here and shown in the figures illustrate how wagering game machines can employ surface conduction electron emitter displays to provide images or video at lower cost, higher resolution, higher brightness, and with lower power consumption than competing technologies. Further, they have shown how the technologies used to produce the surface conduction electron emitter displays can be readily adapted to produce large and odd-dimensioned displays such as the side-panel display of FIG. 4. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized wagering game system, comprising:
a gaming module comprising a processor and gaming code which is operable when executed on the processor to play a wagering game on which monetary value can be wagered; and
a surface conduction electron emitter display.

2. The computerized wagering game system of claim 1, wherein the surface conduction electron emitter display is employed in a top-box.

3. The computerized wagering game system of claim 1, wherein the surface conduction electron emitter display is employed as a main wagering game display.

4. The computerized wagering game system of claim 1, wherein the surface conduction electron emitter display is employed as an attract mode display.

5. The computerized wagering game system of claim 1, wherein the surface conduction electron emitter display employs cathode ray tube phosphors.

6. The computerized wagering game system of claim 1, wherein the surface conduction electron emitter display comprises a plurality of slits, and wherein the application of voltage across one or more of the plurality of slits causes emission of electrons.

7. The computerized wagering game system of claim 6, wherein the emission of electrons is caused by tunneling.

8. The computerized wagering game system of claim 6, wherein the emission of electrons causes fluorescence of a phosphor, resulting in production of visible light.

9. A method of operating a computerized wagering game system, comprising:
a gaming module comprising a processor and gaming code which is operable when executed on the processor to play a wagering game on which monetary value can be wagered; and
a surface conduction electron emitter display.

10. The method of claim 9, wherein the surface conduction electron emitter display is employed in a top-box.

11. The method of claim 9, wherein the surface conduction electron emitter display is employed as a main wagering game display.

12. The method of claim 9, wherein the surface conduction electron emitter display is employed as an attract mode display.

13. The method of claim 9, wherein the surface conduction electron emitter display employs cathode ray tube phosphors.

14. The method of claim 9, wherein the surface conduction electron emitter display comprises a plurality of slits, and wherein the application of voltage across one or more of the plurality of slits causes emission of electrons.

15. The method of claim 14, wherein the emission of electrons is caused by tunneling.

16. The method of claim 14, wherein the emission of electrons causes fluorescence of a phosphor, resulting in production of visible light.

17. A wagering game machine comprising a surface conduction electron emitter display.

18. A method of producing an image on a wagering game machine, comprising operating a surface conduction electron emitter display.
